(19) United States
(12) Patent Application Publication
(10) Pub. No.: US 2026/0086873 A1
(43) Pub. Date: Mar. 26, 2026

(54) TECHNIQUE FOR DETERMINING TARGET DEVICE IN WHICH ARTIFICIAL INTELLIGENCE MODEL IS TO BE EXECUTED

(71) Applicant: NOTA, INC., Daejeon (KR)

(72) Inventor: Sanggeon PARK, Daejeon (KR)

(21) Appl. No.: 18/914,992

(22) Filed: Oct. 14, 2024

(30) Foreign Application Priority Data
Sep. 20, 2024 (KR) 10-2024-0127005

(51) Int. Cl. G06F 9/50

(52) U.S. Cl. CPC G06F 9/5055; G06F 9/5044

(57) ABSTRACT

A method for determining a target device to execute an artificial intelligence (AI) model, performed by a computing device, is disclosed. Upon receiving the AI model from a user terminal, the method extracts model-related information, including runtime, layer, memory, and file size details. The process begins with a first check, sending a signal to a device database to retrieve information about a specific device. It determines whether the model is executable on that device by comparing its runtime information with the model's requirements. If executable, a second check evaluates whether the device's resources—such as memory, file size capacity, and layer support—meet the model's resource conditions. Based on the results, the device may be added to a candidate list of recommended devices for executing the AI model. This ensures optimal device selection for AI model execution.

### CROSS-REFERENCE TO RELATED APPLICATIONS

This application claims priority to and the benefit of Korean Patent Application No. 10-2024-0127005 filed in the Korean Intellectual Property Office on Sep. 20, 2024, the entire contents of which are incorporated herein by reference.

### BACKGROUND

### Technical Field

This disclosure relates to artificial intelligence technology, and more specifically, to a technique for determining target device in which artificial intelligence model is to be executed.

### Description of the Related Art

Due to the development of artificial intelligence technology, various types of artificial intelligence based models are being developed. The demand for computational resources to handle various AI-based models is also increasing, and the development of hardware with new abilities in related industries is continuously developed.

As the demand for edge artificial intelligence, which can lead to a direct operation in terminals on networks such as personal computers, smartphones, cars, wearable devices and robots, increases, research into an AI based model considering hardware resources is conducted.

With the development of edge AI technology and as the importance of hardware in the artificial intelligence technology field increases, in order to develop and launch artificial intelligence based solutions, sufficient knowledge of various hardware in which the artificial intelligence models are to be executed in addition to the artificial intelligence based models is also required. For example, even if there is a model with excellent performance in a specific domain, inference performance for the model can be different for each hardware where the model will be executed. There may also be a situation in which a model with optimal performance in a specific domain is not supported in specific hardware in which a service is to be provided. Accordingly, in order to determine an artificial intelligence model suitable for the service to be provided and hardware suitable for the artificial intelligence model, high levels of background knowledge and vast quantities of resources of the artificial intelligence technology and the hardware technology can be required.

In order to determine whether the artificial intelligence model can normally operate in specific hardware, the corresponding hardware must be purchased, and then tested by distributing the artificial intelligence model. Accordingly, in order for a user to check whether the model operates in specific hardware, a process of distributing each model to actual hardware is required.

Such a constraint may affect a product development period when developing or upgrading a product to which the artificial intelligence model is applied.

US Patent Application Laid-Open No. 2002-0121927 discloses providing a group of neural networks for processing data.

### BRIEF SUMMARY

The present disclosure is contrived in response to the above-described background art, and has been made in an effort to efficiently determine a target device suitable for an artificial intelligence model.

The present disclosure is contrived in response to the above-described background art, and has been made in an effort to efficiently perform a benchmark for the target device of the artificial intelligence model.

The present disclosure is contrived in response to the above-described background art, and has been made in an effort to efficiently change or convert the artificial intelligence model for efficient execution of the artificial intelligence model.

Technical objects of the present disclosure are not restricted to the technical object mentioned above. Other unmentioned technical objects will be apparently appreciated by those skilled in the art by referencing the following description.

In accordance with an embodiment of the present disclosure, a method for determining a target device on which an artificial intelligence model is to be executed, performed by a computing device is disclosed. The method comprises: in response to receiving the artificial intelligence model from a user terminal, extracting information related to the artificial intelligence model, wherein the information related to the artificial intelligence model comprises model runtime information, model layer information, model memory information, and model file size information; when the information related to the artificial intelligence model is extracted, a first checking step: to send a signal, to a device database, requesting information of a first device among a plurality of devices included in the device database, and to determine whether the artificial intelligence model is executable on the first device by using first device runtime information corresponding to the first device and model runtime information of the artificial intelligence model in response to receiving the information of the first device from the device database; when the artificial intelligence model is determined to be executable on the first device in the first checking step, a second checking step to determine whether device resource information of the first device satisfies target resource conditions, which include the model layer information, the model memory information, and the model file size information of the artificial intelligence model; and determining whether to include the first device in a candidate device list recommended for executing the artificial intelligence model, based on a result of the second checking step.

In accordance with an embodiment of the present disclosure, the device resource information comprises: device processor information used to estimate an inference latency of the artificial intelligence model; device memory information indicating a memory type or a memory size of the first device; device runtime information indicating a runtime that is executable on the first device; and device storage space information indicating an available storage capacity of the first device; and wherein the device resource information is mapped to the first device and stored in the device database.

In accordance with an embodiment of the present disclosure, the model memory information is extracted by determining an estimated memory usage when the artificial intelligence model is executed, by using the model runtime information of the received artificial intelligence model, and wherein the model layer information that identifies one or more layers constituting the artificial intelligence model is extracted by using the model runtime information of the received artificial intelligence model.

In accordance with an embodiment of the present disclosure, the method further comprises: when it is determined in the first checking step that the artificial intelligence model is not executable on the first device, transmitting the artificial intelligence model and device runtime information supportable by the first device to a converter; and receiving the artificial intelligence model converted to have device runtime information supportable by the first device from the converter.

In accordance with an embodiment of the present disclosure, the extracting step and the second checking step are performed on the converted artificial intelligence model.

In accordance with an embodiment of the present disclosure, the first checking step determines whether the artificial intelligence model is executable on the first device, by checking if the model runtime information of the artificial intelligence model matches first device runtime information that provides the highest performance among a plurality of device runtime information executable on the first device.

In accordance with an embodiment of the present disclosure, the determining whether to include the first device in the candidate device list comprises: when it is determined in the second checking step that the device resource information of the first device satisfies the target resource conditions of the artificial intelligence model, including the first device in the candidate device list recommended for executing the artificial intelligence model. The method further comprises: generating the candidate device list that includes a plurality of candidate devices including the first device; generating performance information of the artificial intelligence model by executing the artificial intelligence model on a selected target device from the candidate device list; and generating benchmark results including the performance information.

In accordance with an embodiment of the present disclosure, the determining whether to include the first device in the candidate device list comprises: when it is determined that the device resource information of the first device does not satisfy the target resource conditions, excluding the first device from the candidate device list and including the first device in an unsupported device list corresponding to the artificial intelligence model.

In accordance with an embodiment of the present disclosure, the including the first device in the unsupported device list comprises: when device layer information of the device resource information of the first device does not support the model layer information, including the first device in an unsupported layer device list; when device memory information of the device resource information of the first device does not satisfy a size of the model memory information, including the first device in an unsupported memory device list; and when device storage space information of the device resource information of the first device does not satisfy the model file size information, including the first device in an unsupported storage device list.

In accordance with an embodiment of the present disclosure, in the second checking step, it is determined that the device resource information of the first device does not satisfy the target resource conditions when any one of the device layer information, device memory information and device storage space information included in the device resource information of the first device does not satisfy the target resource conditions.

In accordance with an embodiment of the present disclosure, the method further comprises: generating a recommendation message suggesting an additional operation to be applied to the artificial intelligence model to modify the target resource conditions, when it is determined in the second checking step that the device resource information of the first device does not satisfy the target resource conditions of the artificial intelligence model.

In accordance with an embodiment of the present disclosure, the generating the recommendation message comprises: generating the recommendation message including candidate layers supporting a runtime of the first device, when the device layer information in the device resource information does not match the model layer information in the target resource conditions, and wherein the method further comprises: transmitting the recommendation message including candidate layers supporting the runtime of the first device to the user terminal; receiving a user input selecting the candidate layer from the user terminal; transmitting a converting request to the converter to replace at least some of the layers of the artificial intelligence model with the selected candidate layer, in response to receiving the user input; and receiving the converted artificial intelligence model from the converter.

In accordance with an embodiment of the present disclosure, it is determined whether the replacement with the candidate layer requires retraining of the artificial intelligence model, based on the candidate layer and the layer to be replaced in the artificial intelligence model, and the recommendation message indicates whether retraining of the artificial intelligence model is necessary.

In accordance with an embodiment of the present disclosure, the recommendation message is generated to include a memory reduction amount required to match the model memory information to the device memory information and a compression technique of the artificial intelligence model to achieve the memory reduction amount, when the device memory information in the device resource information does not match the model memory information in the target resource conditions. The recommendation message is generated to include a file size reduction amount required to match the model file size information to the device storage space information and a compression technique of the artificial intelligence model to achieve the file size reduction amount, when the device storage space information in the device resource information does not match the model file size information in the target resource conditions. The method further comprises: in response to receiving a user input selecting the compression technique from the user terminal, transmitting a compression request including the selected compression technique and the artificial intelligence model to a compression server to generate a compressed artificial intelligence model; and receiving the compressed artificial intelligence model from the compression server as the selected compression technique is applied to the artificial intelligence model.

In accordance with an embodiment of the present disclosure, the recommendation message is generated to include a memory reduction amount required to match the model memory information to the device memory information and a quantization technique of the artificial intelligence model to achieve the memory reduction amount, when the device memory information in the device resource information does not match the model memory information in the target resource conditions. The recommendation message is generated to include a file size reduction amount required to match the model file size information to the device storage space information and a quantization technique of the artificial intelligence model to achieve the file size reduction amount, when the device storage space information in the device resource information does not match the model file size information in the target resource conditions. The method further comprises: in response to receiving a user input selecting the quantization technique from the user terminal, transmitting a quantization request including the selected quantization technique and the artificial intelligence model to a quantization server to generate a quantized artificial intelligence model; and receiving the quantized artificial intelligence model from the quantization server as the selected quantization technique is applied to the artificial intelligence model.

In accordance with an embodiment of the present disclosure, the method further comprises: identifying unsupported information that does not satisfy the target resource conditions within the device resource information, when it is determined in the second checking step that the device resource information of the first device does not satisfy the target resource conditions of the artificial intelligence model; and generating a recommendation message to suggest an additional operation to satisfy the target resource conditions in different manners according to the identification result of the unsupported information.

In accordance with an embodiment of the present disclosure, the method further comprises: re-performing the first checking step and the second checking step using the artificial intelligence model to which an additional operation is applied and the first device, when the additional operation is applied to the artificial intelligence model according to the recommendation message.

In accordance with an embodiment of the present disclosure, the determining whether to include the first device comprises: a third checking step to determine whether an inference latency of the artificial intelligence model satisfies a predefined target inference latency or whether a power consumption of the artificial intelligence model satisfies a predefined target power consumption when the artificial intelligence model is executed on the first device, when it is determined in the second checking step that the device resource information satisfies the target resource conditions; and determining whether to include the first device in the candidate device list recommended for executing the artificial intelligence model, based on a result of the third checking step.

In accordance with an embodiment of the present disclosure, a computer program stored in a non-transitory computer-readable medium is disclosed. When the computer program is executed by a processor of a computing device, the computer program allows the processor of the computing device to perform a method for a target device on which an artificial intelligence model is to be executed. The method comprises: in response to receiving the artificial intelligence model from a user terminal, extracting information related to the artificial intelligence model, wherein the information related to the artificial intelligence model comprises model runtime information, model layer information, model memory information, and model file size information; when the information related to the artificial intelligence model is extracted, sending a signal, to a device database, requesting information of a first device among a plurality of devices included in the device database, and in response to receiving the information of the first device from the device database, a first checking step to determine whether the artificial intelligence model is executable on the first device by using first device runtime information corresponding to the first device and model runtime information of the artificial intelligence model; when the artificial intelligence model is determined to be executable on the first device in the first checking step, a second checking step to determine whether device resource information of the first device satisfies target resource conditions, which include the model layer information, the model memory information, and the model file size information of the artificial intelligence model; and determining whether to include the first device in a candidate device list recommended for executing the artificial intelligence model, based on a result of the second checking step.

In accordance with an embodiment of the present disclosure, a computing device comprising a processor and a memory is disclosed. The processor performs: in response to receiving the artificial intelligence model from a user terminal, an operation for extracting information related to the artificial intelligence model, wherein the information related to the artificial intelligence model comprises model runtime information, model layer information, model memory information, and model file size information; when the information related to the artificial intelligence model is extracted, a first checking operation: to send a signal, to a device database, requesting information of a first device among a plurality of devices included in the device database, and to determine whether the artificial intelligence model is executable on the first device by using first device runtime information corresponding to the first device and model runtime information of the artificial intelligence model in response to receiving the information of the first device from the device database; when the artificial intelligence model is determined to be executable on the first device in the first checking operation, a second checking operation to determine whether device resource information of the first device satisfies target resource conditions, which include the model layer information, the model memory information, and the model file size information of the artificial intelligence model; and an operation for determining whether to include the first device in a candidate device list recommended for executing the artificial intelligence model, based on a result of the second checking operation.

According to a technique according to an embodiment of the present disclosure, a target device suitable for an artificial intelligence model can be efficiently determined.

According to an embodiment of the present disclosure, a benchmark for the target device of the artificial intelligence model can be efficiently performed.

According to an embodiment of the present disclosure, the artificial intelligence model can be efficiently changed or converted for efficient execution of the artificial intelligence model.

### BRIEF DESCRIPTION OF THE SEVERAL VIEWS OF THE DRAWINGS

FIG. 1 schematically illustrates a block diagram of a computing device according to an embodiment of the present disclosure.

FIG. 2 illustrates an exemplary structure of an artificial intelligence-based model according to an embodiment of the present disclosure.

FIG. 3 illustrates an exemplary flowchart for determining a target device suitable for an artificial intelligence model according to an embodiment of the present disclosure.

FIG. 4 exemplarily illustrates information stored in a device database according to an embodiment of the present disclosure.

FIG. 5 exemplarily illustrates a target resource condition extracted from the artificial intelligence model according to an embodiment of the present disclosure.

FIG. 6 illustrates an exemplary flowchart for generating a candidate device list according to the embodiment of the present disclosure.

FIG. 7 is a schematic view of a computing environment of a computing device according to an embodiment of the present disclosure.

### DETAILED DESCRIPTION

Various embodiments will be described with reference to drawings. In the specification, various descriptions are presented to provide appreciation of the present disclosure.

Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module,” “system,” and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or.” That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A,” “a case including only B,” and “a case in which A and B are combined.”

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

A term device used in the present disclosure may be used interchangeably with hardware. For example, a target device may correspond to hardware information in which an artificial intelligence model is to be executed. For example, the target device may correspond to hardware information in which a benchmark for the artificial intelligence model is to be executed.

The device in the present disclosure may correspond to hardware information which becomes a target of the benchmark of the artificial intelligence model or the hardware information in which the artificial intelligence model is to be executed. For example, the hardware information may be used as a meaning that encompasses physical hardware, virtual hardware, hardware which is impossible to be accessed through the network from the outside, hardware which is impossible to confirm externally, and/or hardware which is confirmed in a cloud. For example, the device in the present disclosure may include various types of hardware such as Jetson Nano, Jetson Xavier NX, Jetson TX2, Jetson AGX Xavier, Jetson AGX Orin, GPU AWS-T4, Xeon-W-2223, Raspberry Pi Zero, Coral, AVH, Raspberry Pi 2W, Raspberry Pi 3B+, Raspberry Pi Zero 4B, and Mobile.

In an embodiment, a candidate device list may mean a set of devices which are capable of executing a received artificial intelligence model, and satisfies a target resource condition (or a target resource condition of the artificial intelligence model changed by converting, compression, and/or quantization) of the received artificial intelligence model. For example, one or more target devices may be determined in response to a user selection on the candidate device list, and a benchmark result indicating a performance measurement result or an estimated performance of the artificial intelligence model for the target device.

The artificial intelligence model in the present disclosure may be used as a meaning that encompasses an artificial intelligence model file and/or artificial intelligence model identification information. In the present disclosure, the artificial intelligence model may include any form of information for identifying the artificial intelligence model. In an embodiment, any form of information for identifying the model may mean any form of information for identifying a runtime, an execution environment, or a framework of the model. For example, TensorRT, Tflite and Onnxruntime may be included in the model identification information. The artificial intelligence model used in the present disclosure may be used interchangeably with a neural network, a network function, a neural network, and the model.

The term “benchmark” used in the present disclosure may mean an operation of executing or testing the artificial intelligence model in the device or an operation of measuring the performance for the device of the artificial intelligence model. A benchmark result or benchmark result information in the present disclosure may include information obtained according to the benchmark or information obtained by processing the information obtained according to the benchmark.

“Device resource information” in the present disclosure may mean any form of information for identifying a resource or a specification of a specific device. For example, the device resource information may include device runtime information for identifying a runtime which is supportable in the device, device processor information for identifying a processor in the device, device memory information for identifying a memory type or a memory size of the device, and/or device storage space information for identifying an available storage capacity of the device.

The “target resource condition” in the present disclosure may be used for identifying conditions or constraints related to the resource required by the artificial intelligence model. The target resource condition may be compared with the device resource in order to generate a candidate device list. The target resource condition may be compared with the device resource in order to determine a candidate device in which the artificial intelligence model is to be executed. For example, the target resource condition may include model layer information for identifying a layer(s) constituting the artificial intelligence model, model memory information for identifying a size of a memory occupied when the model is executed, and/or model file size information for identifying a size of the model file. As the target resource condition and the resource information of each device are compared, a candidate device list recommended for the artificial intelligence model may be generated. The target resource condition may be changed as the artificial intelligence model is converted, compressed, and/or quantized.

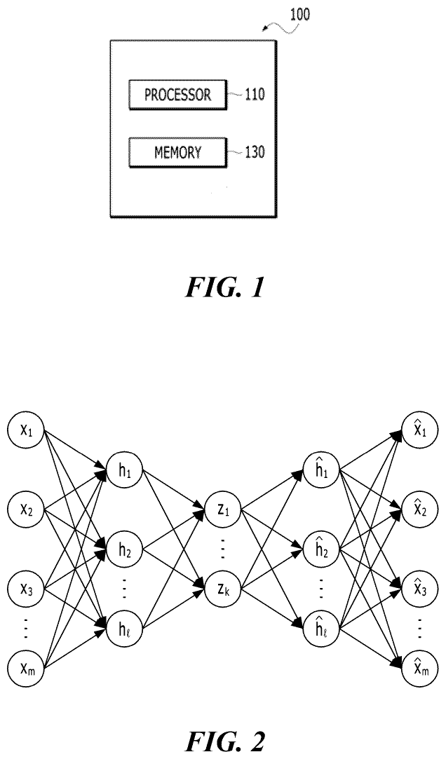

FIG. 1 schematically illustrates a block diagram of a computing device 100 according to an embodiment of the present disclosure.

The computing device 100 according to an embodiment of the present disclosure may include a processor 110 and a memory 130.

A configuration of the computing device 100 illustrated in FIG. 1 is only an example simplified and illustrated. In an embodiment of the present disclosure, the computing device 100 may include other components for performing a computing environment of the computing device 100, and only some of the disclosed components may constitute the computing device 100.

The computing device 100 in the present disclosure may be interchangeably used with the computing device, and the computing device 100 may be used as a meaning that encompasses an any type of server and an any type of terminal.

The computing device 100 in the present disclosure may mean an any type of component constituting a system for implementing the embodiments of the present disclosure.

The computing device 100 may mean an any type of user terminal or an any type of server. The components of the computing device 100 are exemplary, and some components may be excluded or an additional component may also be included. As an example, when the computing device 100 includes the user terminal, an output unit (not illustrated) and an input unit (not illustrated) may be included in a range of the computing device 100.

In an embodiment, the computing device 100 may generate a candidate device list recommended for an input (e.g., received) artificial intelligence model. In an embodiment, the computing device 100 may determine a target device in which the input artificial intelligence model is to be executed. In an embodiment, the computing device 100 may perform converting, compression, and/or quantization for the input artificial intelligence model.

In an embodiment, the computing device 100 may perform a first checking of determining whether the artificial intelligence model is executable in a specific device. In an embodiment, the computing device 100 may perform a second checking of determining whether a specific device satisfies a target resource condition by using a target resource condition of the artificial intelligence model and device resource information of the specific device.

In an embodiment, the computing device 100 may communicate with a plurality of devices, and generate benchmark results for the artificial intelligence model and the device. In an embodiment, the computing device 100 may mean a device that manages and/or performs the benchmark for the plurality of devices the artificial intelligence model. For example, the computing device 100 may include a device farm or may be called the device farm.

In an embodiment, the computing device 100 may determine a target model to be executed based on a candidate model list including candidate artificial intelligence models including a plurality of candidate models, and determine a target device in which a target model is to be executed based on a candidate device list including a pluraFlity of candidate devices. In such an example, the computing device 100 may provide a benchmark result obtained by executing the target model in the target device.

In an embodiment, the computing device 100 may perform an operation of converting the artificial intelligence model into a model that is supportable by the candidate device or the target device. In an embodiment, the computing device 100 may perform an operation of converting the artificial intelligence model so that the artificial intelligence model may be efficiently executed by the candidate device or the target device. The computing device 100 may provide the converted model in a downloadable form. The computing device 100 may generate a benchmark result obtained by executing the converted artificial intelligence model by the target device.

In an embodiment, the computing device 100 may generate an artificial intelligence model trained from a training dataset by interacting with a user, generate a compressed model for the input artificial intelligence model, generate a quantized model for the input artificial intelligence model, and/or generate download data for deploying the artificial intelligence model to the target device.

In another embodiment of the present disclosure, the computing device 100 may also obtain the result of performing the benchmark from another computing device or an external entity. In another embodiment of the present disclosure, the computing device 100 may also obtain a result of performing converting from another computing device or an external entity (e.g., a converting device). In another embodiment of the present disclosure, the computing device 100 may also obtain a result of performing compression for the model from another computing device or the external entity (e.g., the converting device). In another embodiment of the present disclosure, the computing device 100 may also obtain a result of performing quantization for the model from another computing device or the external entity (e.g., the converting device).

In an embodiment, the processor 110 may be constituted by at least one core, and include processors for data analysis and processing, such as a central processing unit (CPU), a general purpose graphics processing unit (GPGPU), a tensor processing unit (TPU), etc., of the computing device 100.

The processor 110 may read a computer program stored in the memory 130 to perform the method according to an exemplary embodiment of this disclosure. In one embodiment, the memory 130 may include a storage unit for storing information, and for example, the device database of this disclosure may be included within this memory 130.

According to an embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process learning of the network function. For example, the CPU and the GPGPU may process the learning of the network function and data classification using the network function. Further, in an embodiment of the present disclosure, learning of the network function and data classification using the network function may also be processed by using processors of a plurality of computing devices. In addition, the computer program performed by the computing device 100 according to an embodiment of the present disclosure may be a CPU, GPGPU, or TPU executable program.

Additionally, the processor 110 may generally process all operations of the computer device 100. For example, the processor 110 processes data, information, or a signal input or output through the components included in the computing device 100 or drives an application program stored in a storage unit to provide an appropriate information or function to a user.

According to an embodiment of the present disclosure, the memory 130 may store various types of information generated or determined by the processor 110 or various types of information received by the computing device 100. According to an embodiment of the present disclosure, the memory 130 may be a storage medium storing computer software which performs the operations according to the embodiments of the present disclosure by the processor 110. Therefore, the memory 130 may also mean computer reading media for storing a software code required for performing the embodiment of the present disclosure, data which becomes an execution target of the code, and an execution result of the code.

The memory 130 according to an embodiment of the present disclosure may mean an arbitrary type of storage medium. For example, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may also operate in connection with a web storage performing a storing function of the memory 130 on the Internet. The disclosure of the memory is just an example, and the memory 130 used in the present disclosure is not limited to the examples.

A communication unit (not illustrated) in the present disclosure may be configured regardless of communication modes such as wired and wireless modes and constituted by various communication networks including a personal area network (PAN), a wide area network (WAN), and the like. Further, the network unit 150 may be the known World Wide Web (WWW) and may adopt a wireless transmission technology used for short-distance communication, such as infrared data association (IrDA) or Bluetooth.

The computing device 100 in the present disclosure may include various types of user terminal and/or various types of server. Therefore, the embodiments of the present disclosure may be performed by the server and/or the user terminal.

In an embodiment, the user terminal may include an arbitrary type of terminal which is capable of interacting with the server or another computing device. The user terminal may include, for example, a cellular phone, a smart phone, a laptop computer, a personal digital assistant (PDA), a slate PC, a tablet PC, and an ultrabook.

In an embodiment, the server may include, for example, various types of computing system or computing device such as a microprocessor, a mainframe computer, a digital processor, a portable device, and a device controller.

FIG. 2 illustrates an illustrative structure of an artificial intelligence based model according to an embodiment of the present disclosure.

Throughout the present disclosure, the model, the artificial intelligence model, the artificial intelligence based model, the operation model, and the neural network, the network function, and the neural network may be used interchangeably.

The artificial intelligence based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node.” The nodes may also be called neurons. The neural network is configured to include one or more nodes. The nodes (or neurons) constituting the neural networks may be mutually connected to each other by one or more links.

The node in the artificial intelligence based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers.

The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an embodiment of the present disclosure, the set of the neurons or the nodes may be defined as the expression “layer.”

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another embodiment of the present disclosure, the number of nodes of the input layer may be smaller than the number of nodes of the output layer, and the neural network may be a neural network of a type in which the number of nodes increases from the input layer to the hidden layer.

Further, in the neural network according to yet another embodiment of the present disclosure, the number of nodes of the input layer may be larger than the number of nodes of the output layer, and the neural network may be a neural network of a type in which the number of nodes decreases from the input layer to the hidden layer. The neural network according to still yet another embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, potential structure of music (e.g., what objects are in the photo, what is the content and emotions of the text, what contents and emotions of the voice, etc.), and/or the binding affinity between the peptide and the MHC may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an embodiment of the present disclosure, a computer readable medium is disclosed, which stores a data structure including the benchmark result and/or the artificial intelligence based model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO—Last in First Out) in which the data is input last and output first. The queue is a data listing structure that may access data limitedly and unlike a stack, the queue may be a data structure (FIFO—First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node.” The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

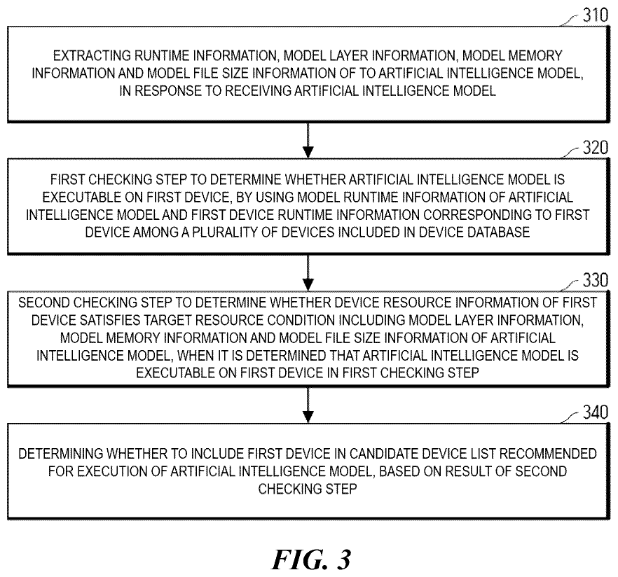

FIG. 3 illustrates an exemplary flowchart for determining a target device suitable for an artificial intelligence model according to an embodiment of the present disclosure.

Steps illustrated in FIG. 3 are expressed for an exemplary purpose, and according to an implement aspect, an additional step(s) may be added to the flowchart of FIG. 3 or some of the step(s) of FIG. 3 may also be excluded from the flowchart of FIG. 3.

In an embodiment, the computing device 100 may extract model runtime information, model layer information, model memory information, and model file size information of the artificial intelligence model in response to receiving the artificial intelligence model.

In an embodiment, the computing device 100 may receive the artificial intelligence model from a user terminal. The computing device 100 may extract information (e.g., model runtime information, model memory information, and model file information) related to the artificial intelligence model in response to receiving the artificial intelligence model from the user terminal.

“Automatically” in the present disclosure may mean that a specific process is performed by the computing device 100 according to a predetermined method or condition. For example, “automatically” may be used to express that the computing device 100 autonomously operates without an input of the user or intervention by the user.

In an embodiment, the computing device 100 may receive the artificial intelligence model. For example, the artificial intelligence model may include a model file delivered to the computing device 100 to be executed by a specific device. For example, the artificial intelligence model may include a model file corresponding to the trained artificial intelligence model. For example, the artificial intelligence model may include model identification information for identifying the artificial intelligence model. For example, the artificial intelligence model may include a training dataset for training the artificial intelligence model. For example, the artificial intelligence model may be input to the computing device 100 by a user input.

In an embodiment, the computing device 100 may extract the model runtime information, model layer information, model memory information, and model file size information from the received artificial intelligence model.

In an embodiment, the model runtime information may mean environmental, systematic, and/or performance data generated when the model is executed. For example, the model runtime information may include a memory usage, a calculation speed of the model, power consumption, and/or a network usage while the model is executed.

In an embodiment, the model runtime information may be used to express how the artificial intelligence model operates in a specific hardware or software environment, what resource the artificial intelligence model uses, and/or how efficiency the artificial intelligence model is.

In an embodiment, the model runtime information may include information related to a framework in which the model is executable. In such an embodiment, the model runtime information may include TensorFlow, PyTorch, Keras, MXNet, and ONNX.

In an embodiment, the model runtime information may be obtained by parsing the artificial intelligence model. In an embodiment, the model runtime information may be obtained by using a specific profiling program (e.g., TensorFlow Profiler and/or PyTorch Profiler) as an artificial intelligence model file. In an embodiment, the model runtime information may be extracted through log data generated while the artificial intelligence model is executed by a specific device. In an embodiment, the model runtime information may be obtained by adding a predetermined collection code to a model code of the artificial intelligence model.

In an embodiment, when the model runtime information is extracted, other factors constituting the target resource condition of the artificial intelligence model may be extracted using the model runtime information. In an embodiment, an estimated memory usage when the artificial intelligence model is executed may be determined using the model runtime information of the received artificial intelligence model. The model memory information of the artificial intelligence model may be extracted based on the estimated memory usage.

In an embodiment, the model layer information that identifies one or more layers constituting the artificial intelligence model may be extracted by using the model runtime information of the received artificial intelligence model. The layer in the present disclosure may mean a basic unit of the artificial intelligence model (e.g., neural network) configured to perform a specific operation by receiving input data and deliver a result of the operation to a subsequent layer. As a non-limited example, the layer may include a Fully Connected Layer, a Convolutional Layer, a Pooling Layer, a Normalization Layer, a Dropout Layer, an Embedding Layer, and/or an Attention Layer. In an embodiment, the model layer information may be extracted from the artificial intelligence model file by using a function or a method provided by a deep learning framework. In an embodiment, the model layer information may be extracted by using a custom code added to extract the model layer information.

In an embodiment, the model memory information may be extracted by using a profiling tool provided by the deep learning framework. In an embodiment, the model memory information may be extracted by inserting a code capable of tracking the memory usage into a model code of the artificial intelligence model. In an embodiment, the model memory information may be extracted through a monitoring tool or a logging tool which monitors the memory usage when the artificial intelligence model is executed by each of the plurality of devices, and as an example, the model memory information may be obtained by averaging memory usages of the artificial intelligence model in the plurality of devices.

In an embodiment, the model file size information may be checked by parsing a capacity occupied by the received artificial intelligence model. In an embodiment, the model file size information may include information for identifying a file size occupied in the device when the artificial intelligence mode is executed. As an example, the model file size information may also be obtained from the model runtime information.

In an embodiment, the computing device 100 may perform a first checking step of determining, by using first device runtime information corresponding to a first device among a plurality of devices included in a device database, and the model runtime information of the artificial intelligence model, whether the artificial intelligence model is executable by the first device (320).

In an embodiment, whenthe information related to the artificial intelligence model is extracted in step 310, the computing device 100 may transmit, to the device database, a signal for requesting information on the first device among the plurality of devices included in the device database. The computing device 100 may receive, from the device database, the information on the first device. The computing device 100 may determine whether the artificial intelligence model is executable by the first device by using the first device runtime information corresponding to the first device, and the model runtime information of the artificial intelligence model in response to receiving the information on the first device from the device database. By such a method, the computing device 100 may perform the first checking step.

In an embodiment, the first checking step may use the runtime information of the device and the runtime information of the artificial intelligence model. In an embodiment, the first checking step may determine whether the artificial intelligence model is compatible or executable in a specific device by using the device runtime information and the model runtime information. In an embodiment, the first checking step may determine whether the artificial intelligence model is compatible or executable in the specific device by comparing the device runtime information and the model runtime information.

For example, the computing device 100 may extract the first device from the device database storing the plurality of devices, and perform the first checking step using the first device and the artificial intelligence model. The computing device 100 may extract a second device from the device database, and perform the first checking step using the second device and the artificial intelligence model. As described above, the computing device 100 may perform the first checking step of comparing the information on the device stored in the device database and the information on the received artificial intelligence model to determine whether the corresponding device is compatible with the corresponding artificial intelligence model.

In an embodiment, the first checking step may be a process for determining a compatibility of the device and the model.

In an embodiment, the first checking step may include a process of comparing a framework supportable by the first device and a framework of the artificial intelligence model.

In an embodiment, the first checking step may include comparing first device runtime information determined to provide a highest performance in the first device among a plurality of device runtime information executable by the first device, and the model runtime information of the artificial intelligence model. For example, when it is determined that the device runtime information of the first device matches the model runtime information, it may be determined that the first checking step may be passed. For example, when one model runtime information among the plurality of device runtime information mapped to the first device is matched, it may be determined that the first checking step may be passed. For example, when it is determined that the device runtime information of the first device matches the model runtime information, it may be determined that the artificial intelligence model is compatible with the first device. For example, when it is determined that the device runtime information of the first device matches the model runtime information, it may be determined that the artificial intelligence model is executable by the first device.

In an embodiment, when it is determined that the artificial intelligence model is not executed by the first device in the first checking step, the first device will be included in an unsupported device list for the artificial intelligence model, and the first checking step using the second device different from the first device, and the artificial intelligence model may be performed.

In an embodiment, when it is determined that the artificial intelligence model is not executable by the first device in the first checking step, the computing device 100 may determine whether the artificial intelligence model is convertible into device runtime information supportable by the first device. When the artificial intelligence model is convertible into the device runtime information, the computing device 100 may convert the artificial intelligence model so that the artificial intelligence model has the device runtime information. For example, the converting of the artificial intelligence model may mean transforming the artificial intelligence model so that the artificial intelligence model is operable in a different framework. For example, the converting of the artificial intelligence model may be performed by using a converting identifier generated by combining a model identifier before the converting and a model identifier after the converting. For example, the converting of the artificial intelligence model may be implemented through any form of converter and transformer providing a model transform function.

In an embodiment, when it is determined that the artificial intelligence model is not executable by the first device in the first checking step, the computing device 100 may transmit the device runtime information supportable by the artificial intelligence model and the first device to the converter. The computing device 100 may receive, from the converter, the artificial intelligence model converted to have the device runtime information supportable by the first device. The converter in the present disclosure may correspond to, for example, a converter server which is present outside the computing device 100. The converter in the present disclosure may correspond to, for example, a module which is integrated into the computing device 100 and is operable. In an embodiment, the converter may mean a module or a device which converts a runtime, a framework, an operator, and/or a layer of the artificial intelligence model to enable a compatibility between various artificial intelligence frameworks. The converter may be used to effectively distribute or execute artificial intelligence models in different execution environments. In an embodiment, the computing device 100 may generate or obtain the artificial intelligence model converted so that the artificial intelligence model may have device runtime information supportable by a specific device by interacting with the converter.

In an embodiment, the computing device 100 checks whether the first device runtime information determined to provide a highest performance (e.g., smallest latency and/or smallest power consumption) in the first device among a plurality of device runtime information executable by the first device, and the model runtime information of the artificial intelligence model match each other to determine whether the artificial intelligence model is executable by the first device.

In an embodiment, when the artificial intelligence model is not convertible into the device runtime information, the first device will be included in the unsupported device list for the artificial intelligence model, and the first checking step using the second device different from the first device, and the artificial intelligence model may be performed.

In an embodiment, when it is determined that the artificial intelligence model is executable by the first device in the first checking step, the computing device 100 may perform a second checking step of determining whether the device resource information of the first device satisfies the target resource condition including the model layer information, the model memory information, and the model file size information of the artificial intelligence model (330).

In an embodiment, when it is determined that the artificial intelligence model is executable by the first device in the first checking step, the computing device 100 may perform the second checking step of determining whether the device resource information of the first device satisfies the target resource condition (e.g., a condition related to the model layer information, a condition related to the model memory information, and/or a condition related to the model file size information) including the model layer information, the model memory information, and the model file size information of the artificial intelligence model.

In an embodiment, the second checking step may include an additional checking process of using the device and the artificial intelligence model which pass through the first checking step.

The technique according to an embodiment of the present disclosure may perform may determine the compatibility and the executability between the artificial intelligence model and the device in the first checking step, and perform the second checking step for the device and the artificial intelligence model which pass through the first checking step. As such serial or sequential checking steps are performed, an advantage that the candidate device recommended for the artificial intelligence model may be determined by a more resource-efficient method may be achieved.

According to another embodiment of the present disclosure, a checking step in which factors (e.g., runtime information) or methods used in the first checking step and factors or methods used in the second checking step are integrated and used in one step may also be included in the scope of the present disclosure.

According to another embodiment of the present disclosure, a plurality of checking steps in which the factors (e.g., runtime information) or methods used in the first checking step and the factors or methods used in the second checking step are performed in parallel may also be included in the scope of the present disclosure.

In an embodiment, the second checking step may be performed by a method of comparing the device resource information and the model resource information.

In an embodiment, the second checking step may be performed by a method of comparing the device resource information of the device and the target resource condition of the artificial intelligence model. For example, when the device resource information and the target resource condition match each other, it may be determined that the second checking step is passed. For example, when the device resource information satisfies all target resource conditions, it may be determined that the second checking step is passed. For example, when the device resource information does not satisfy even any one of the target resource conditions, it may be determined that the second checking step is not passed. In this case, as a subsequent procedure for the second checking step, an additional processing process for the artificial intelligence model for changing the target resource condition may be proposed or recommended.

In an embodiment, a device which passes through the second checking step may be included in the candidate device list. In an embodiment, a device which does not pass through the second checking step may be included in the unsupported device list.

In an embodiment, the device resource information may include device processor information used to estimate an inference latency when the artificial intelligence model is executed, device memory information indicating a memory type or a memory size of the device, device runtime information indicating a runtime executable in the device, and device storage space information indicating an available storage capacity of the device. The device resource information may be stored in the device database jointly with the device identification information. The device resource information may be mapped to the device identification information, and the device resource information and the device identification information may be jointly stored in the device database.

In an embodiment, the target resource condition may mean a condition related to the resource of the received artificial intelligence model. For example, the target resource condition may include model layer information for identifying the layer of the artificial intelligence model, model memory information indicating a memory usage when the artificial intelligence model is used by the device, and/or model file size information indicating how large storage space the artificial intelligence model occupies when the artificial intelligence model is executed by the device or stored in the device. For example, the target resource information may be configured by any form of combinations of the information.

In an embodiment, the second checking step may include a process of determining whether all plurality of respective information included in the target resource condition matches the device resource information. For example, when the resource information satisfies all of the plurality of information included in the target resource condition, it may be determined that the second checking step is passed. For example, when the device resource information does not satisfy one or more of the plurality of information included in the target resource condition, it may be determined that the second checking step is not passed. In an embodiment, the second checking step may include a process of comparing the plurality of respective information included in the target resource condition and respective device resource information. Here, the comparison may include, for example, comparing whether corresponding device resource information matches each information included in the target resource condition.

In an embodiment, the comparison in the second checking step may be performed in a different method according to what specific information of the target resource condition which becomes a target of the comparison is, for example. In an embodiment, the comparison may include, for example, determining whether the corresponding device resource information is equal to or more than a size of each information included in the target resource condition. In an embodiment, the comparison may include, for example, determining whether the corresponding device resource information is more than the size of each information included in the target resource condition.

In an embodiment, the computing device 100 may determine whether to include the first device in the candidate device list recommended for executing the artificial intelligence model based on a result of the second checking step (340).

In an embodiment, the computing device 100 may determine whether to include the first device in the candidate device list recommended for executing the artificial intelligence model based on a result of the second checking step (e.g., a result for whether the resource information of the first device satisfies the target resource conditions or some of the target resource conditions).

In an embodiment, when it is determined that the device resource information of the first device satisfies the target resource condition of the artificial intelligence model in the second checking step, the computing device 100 may include the first device in the candidate device list recommended for executing the artificial intelligence model. In an embodiment, the computing device 100 may generate a candidate device list including a plurality of candidate devices including a device which passes through the second checking step. The candidate device list may mean a list of devices which are capable of executing the artificial intelligence model and satisfy the resource condition of the artificial intelligence model. Since the device included in the candidate device list is a device which satisfies a constraint of the received artificial intelligence model, the device may be defined as a device which may guarantee excellent execution of the artificial intelligence model.

In an embodiment, when the artificial intelligence model is executed by each of a plurality of candidate devices recommended for the benchmark, the computing device 100 may provide a candidate node list including estimated performance information in each of the plurality of candidate devices. In an embodiment, the candidate device list may include identification information for each of the candidate devices. As an example, the candidate device list may include estimated performance information (e.g., latency information) when the artificial intelligence model is executed by each of the candidate devices. As an example, the candidate device list may include both identification information of each of the candidate devices, and performance information (e.g., estimated performance information) when the artificial intelligence model is executed by each of the candidate devices. As an example, the candidate device list may include a plurality of candidate devices recommended for the benchmark of the artificial intelligence model. As an example, the candidate device list may include a plurality of candidate devices recommended for executing the artificial intelligence model. As described above, when an input for the artificial intelligence model is received from the user, the computing device 100 may determine the candidate devices recommended for the artificial intelligence model by using the device database, and the first and second checking steps.

In an embodiment, the candidate device list may further include first information indicating whether converting is applied to the artificial intelligence model and/or second information indicating whether optimization (e.g., compression and/or quantization) is applied to the artificial intelligence model according to a recommendation message. For example, the first information may further include model identification information before converting and model identification information after converting. For example, the second information may further include optimization identification information for identifying an optimization method applied to the artificial intelligence model. For example, the optimization identification information may include a compression method, a quantization method, a format before quantization, a format after quantization, a compression rate, and/or information for identifying a compression target layer. In an embodiment, in the candidate device list, the first information, the second information, information for identifying the candidate devices, runtime information of the candidate devices, runtime information of the artificial intelligence model, and/or performance information when the artificial intelligence model is executed in each of the candidate devices may be grouped, and displayed or managed. In the process of the first checking and/or the second checking, the artificial intelligence model is changed, and then the first checking and/or the second checking may be re-performed, and as a result, when generating the candidate device list, the computing device 100 may include information related to the change of the artificial intelligence model in previous checking(s) in the candidate device list.

In an embodiment, the computing device 100 may generate a benchmark result including performance information (e.g., actual performance information) when the artificial intelligence model is executed in the target device selected on the candidate device list. In an embodiment, the benchmark result may mean information obtained based on a result of executing a specific model on a specific device. As an example, the benchmark result may be generated based on a result of a benchmark performed in the past. As an example, the benchmark result may include information determined based on actually measured information in the past. As an additional example, the benchmark result may also correspond to benchmark estimation information or benchmark prediction information determined based on the past actual measurement information. For example, the benchmark result may include latency information.

In an embodiment, the computing device 100 may generate a candidate device list including the plurality of candidate devices including the first device, and execute the artificial intelligence model in the target device selected on the candidate device list. The computing device 100 executes the artificial intelligence model in the selected target device to generate performance information of the artificial intelligence model and generate a benchmark result including the performance information.

In an embodiment, the benchmark result or performance information may include a result of executing a specific model in a specific device. For example, the benchmark result or performance information may include latency information, power consumption information, and/or memory usage information.

In an embodiment, the benchmark result may include performance information for the specific model in the specific node based on actual measurement.

In an embodiment, when the device resource information of the first device does not satisfy the target resource condition, the computing device 100 may not include the first device in the candidate device list, but include the first device in an unsupported device list corresponding to the artificial intelligence model.

In an embodiment, the unsupported device list may be generated as a sub condition unit which is not satisfied among the target resource conditions. For example, the unsupported device list may include an unsupported layer device list, an unsupported memory device list, and/or an unsupported storage device list.

In an embodiment, the computing device 100 may include the first device in the unsupported layer device list when the device layer information among the device resource information of the first device does not correspond to the model layer information among the target resource conditions (for example, when the device does not support a layer corresponding to the model layer information). As an example, the device layer information may be extracted by using the device runtime information stored in the device database. As an example, the device layer information may also be stored in the device database as separate information.

In an embodiment, the computing device 100 may include the first device in the unsupported layer device list when the device memory information among the device resource information of the first device does not correspond to a size of the model memory information among the target resource conditions (for example, when the model memory information is larger than the available memory size of the device).

In an embodiment, the computing device 100 may include the first device in an unsupported storage device list when the device storage space information among the device resource information of the first device does not correspond to the model file size information among the target resource conditions (for example, when the model file size is larger than the storage space (e.g., available storage space) of the device).

In an embodiment, in the second checking step, when even any one of the device layer information, the device memory information, and the device storage space information included in the device resource information of the first device does not satisfy the target resource condition, the computing device 100 may determine that the device resource information of the first device does not satisfy the target resource condition.

In an embodiment, when the device resource information does not satisfy the target resource condition according to a result of performing the second checking step, the computing device 100 may generate a recommendation message which recommends an operation for changing the target resource condition. For example, when it is determined that the device resource information of the first device does not satisfy the target resource condition of the artificial intelligence model in the second checking step, the computing device 100 may generate a recommendation message which recommends an additional operation to be applied to the artificial intelligence model in order to change the target resource condition (for example, in order to allow the device resource information to satisfy the target resource information). In an embodiment, when it is determined that the device resource information of the first device does not satisfy the target resource condition of the artificial intelligence model in the second checking step, the computing device 100 may identify unsupported information which does not satisfy the target resource condition in the device resource information. The computing device 100 may determine what the device resource information not satisfying the target resource condition is. The computing device 100 may generate a recommendation message which recommends an additional operation for satisfying the target resource condition by a different method according to a result of identification of the unsupported information. The computing device 100 may generate a recommendation message having a different content according to which resource information among the target resource conditions is not satisfied. The computing device 100 may generate the recommendation message which recommends the additional operation for satisfying the target resource condition by a different method according to the result of identification of the unsupported information. For example, the different method may mean that additional operations (e.g., compression, converting, and/or quantization) to be included in the recommendation message is different.

In an embodiment, additional operations to be applied to the artificial intelligence model may include a converting operation that involves a change in layer, a compression operation that reduces a memory size and/or a size of the storage space, and/or a quantization operation that reduces the memory size and/or the size of the storage space.

In an embodiment, when the device layer information among the device resource information does not match the model layer information among the target resource conditions, the computing device 100 may generate a recommendation message including a candidate layer supporting the runtime of the first device. For example, the recommendation message may include recommending the change of the model layer information to the candidate layer which supports the runtime of the first device. In such an embodiment, in response to a user input of selecting the candidate layer, the computing device 100 may perform converting of replacing at least some of the layers of the artificial intelligence model with the selected candidate layer.

In an embodiment, the computing device 100 may transmit a recommendation message including a candidate layer that supports the runtime of the first device to the user terminal. The computing device 100 may receive the user input of selecting the candidate layer from the user terminal. The computing device 100 may transmit, to the converter, a converting request for replacing at least some of the layers of the artificial intelligence model with the selected candidate layer in response to receiving the user input. For example, the converting request may include the selected candidate layer and the layer to be replaced. The computing device 100 may receive the converted artificial intelligence model from the converter.

In an embodiment, the computing device 100 may determine whether re-training the converted artificial intelligence model is required when converting into the candidate layer is made. For example, based on the candidate layer and the layer to be replaced in the artificial intelligence model, whether replacement with the candidate layer requires re-training the artificial intelligence model may be determined. The recommendation message may represent whether re-training the artificial intelligence model is required. For example, when the user approves the additional operation of the model according to the recommendation message, the converted model may be re-trained based on whether the artificial intelligence model is re-trained.

In an embodiment, whether re-training the artificial intelligence model is required may be determined based on the identification information of the layer.

In an embodiment, the necessity for the re-training of the artificial intelligence model may be variably determined according to an identifier of the layer after replacement. For example, when the layer of the artificial intelligence model is replaced with layer A, it may be determined that re-training the corresponding artificial intelligence model is not required, and when the layer of the artificial intelligence model is replaced with layer B, it may be determined that re-training the corresponding artificial intelligence model is required.

In an embodiment, the necessity for the re-training of the artificial intelligence model may be variably determined according to an identifier of a layer before replacement. For example, when layer A of the artificial intelligence model is replaced, it may be determined that re-training the corresponding artificial intelligence model is not required, and when layer B of the artificial intelligence model is replaced, it may be determined that re-training the corresponding artificial intelligence model is required.

In an embodiment, when the device memory information among the device resource information does not match the model memory information among the target resource conditions, the computing device 100 may generate a recommendation message to include a memory reduction amount required to match the model memory information with the device memory information, and a compression technique of the artificial intelligence model for achieving the memory reduction amount. As a result, the compression amount, the compression technique, the compression rate, etc., of the model may be included in the recommendation message. In an embodiment, when the device storage space information among the device resource information does not match the model file size information among the target resource conditions, the computing device 100 may generate a recommendation message to include a file size reduction amount required to match the model file size information with the device storage space information, and a compression technique of the artificial intelligence model for achieving the file size reduction amount. In an embodiment, in response to a user input of selecting the compression technique, the computing device 100 applies the selected compression technique to the artificial intelligence model to generate a compressed artificial intelligence model.

In an embodiment, the computing device 100 may receive the user input of selecting the compression technique from the user terminal. In response to receiving the user input from the user terminal, the computing device 100 may transmit, to a compression server, a compression request including the selected compression technique and the artificial intelligence model to generate the compressed artificial intelligence model. As an example, the compression request may further include a target memory size according to a compressed result and/or a target file size according to the compressed result. As an example, the compression request may further include a target memory size according to a compressed result and/or a target file size according to the compressed result. The computing device 100 may receive the compressed artificial intelligence model as the compression technique selected from the compression server is applied to the artificial intelligence model. The compression server in the present disclosure may mean a device or a module for performing the compression operation, and may be present outside the computing device 100 or may be integrated and operated inside the computing device 100.

In an embodiment, when the device memory information among the device resource information does not match the model memory information among the target resource conditions, the computing device 100 may generate a recommendation message to include a memory reduction amount required to match the model memory information with the device memory information, and a quantization technique of the artificial intelligence model for achieving the memory reduction amount. In an embodiment, when the device storage space information among the device resource information does not match the model file size information among the target resource conditions, the computing device 100 may generate a recommendation message to include a file size reduction amount required to match the model file size information with the device storage space information, and the quantization technique of the artificial intelligence model for achieving the file size reduction amount. In an embodiment, in response to a user input of selecting the quantization technique, the computing device 100 applies the selected quantization technique to the artificial intelligence model to generate a quantized artificial intelligence model.

In an embodiment, the computing device 100 may receive the user input of selecting the quantization technique from the user terminal. In response to receiving the user input of selecting the quantization technique from the user terminal, the computing device 100 may transmit, to a compression server, the computing device 100 may transmit, to a quantization server, a quantization request including the selected quantization technique and the artificial intelligence model to generate the quantized artificial intelligence model. As an example the quantization request may represent a quantized result. As an example, the quantization request may further include the file size reduction amount and/or the memory size reduction amount. As an example, the quantization request may further include a target file size and/or a target memory size. The computing device 100 may receive the quantized artificial intelligence model from the quantization server as the selected quantization technique is applied to the artificial intelligence model. The quantization server in the present disclosure may mean a device or a module for performing the quantization operation, and may be present outside the computing device 100 or may be integrated and operated inside the computing device 100.

In an embodiment, when the additional operation is applied to the artificial intelligence model according to the recommendation message, the computing device 100 may re-perform the first checking step and/or the second checking step by using the artificial intelligence model to which the additional operation is applied and the first device. The target resource condition and/or the runtime information of the artificial intelligence model may be changed according to the artificial intelligence model to which the additional operation according to the recommendation message is applied, and as a result, the first checking step and/or the second checking step of comparing the information on the first device and the information the artificial intelligence model may be re-performed.

In an embodiment, the computing device 100 may perform a third checking step after the second checking step. Here, the third checking step may be performed when the second checking step is passed. The third checking step may be integrated with the first checking step and the second checking step jointly to constitute one checking step. For example, the third checking step may include a condition related to an inference performance of the model, a condition related to power consumption, a condition related to a heat generation amount, and/or a condition related to a fan usage.

In an embodiment, when it is determined that the device resource information satisfies the target resource condition in the second checking step, the computing device 100 may perform the third checking step of determining whether an inference latency when the artificial intelligence model is executed by the first device satisfies a predetermined target inference latency or determining whether power consumption when the artificial intelligence model is executed by the first device satisfies predetermined target power consumption. The computing device 100 may determine whether to include the first device in the candidate device list recommended for executing the artificial intelligence model based on a result of the third checking step. As described above in the second checking step, a device which passes through the third checking step may be included in the candidate device list, and a device which does not the third checking step may be excluded from the candidate device list or a recommendation message which proposes an additional operation for changing a condition which is not passed in the third checking step may be generated.

In an additional embodiment, according to an implementation aspect, an N-th checking step may be added (N is a natural number). For example, since an additional checking step including an additional condition of a user related to the artificial intelligence model or a predetermined automatic set additional condition may be added to the method of the present disclosure, candidate devices suitable for a customized condition may be determined by a resource efficient method.

The technique according to an embodiment of the present disclosure sequentially uses a plurality of checking steps to sequentially filter candidate devices suitable for the received artificial intelligence model to be determined resource-efficiently.

The technique according to an additional embodiment of the present disclosure may perform one checking step generated by integrating the plurality of checking steps. For example, a method which integrates and processes target resource conditions used in N checking steps in one step may also be implemented according to an implementation aspect. For example, the runtime information, the memory information, the layer information, the storage space information, the inference time information, and/or power consumption information are/or used in one checking step to automatically determine the candidate devices recommended for the artificial intelligence model.

The technique according to an embodiment of the present disclosure may predetermine a calculation ability of the device, a memory capacity, a storage space capacity, a supported runtime, and/or a supported layer, and efficiently and/or automatically determine candidate devices recommended an artificial intelligence model to be driven by the user as a minimum memory condition required for driving the artificial intelligence model, a minimum storage space condition, a driving layer condition, and/or a driving runtime condition are/is secured in advance. Through this, in the technique according to an embodiment of the present disclosure, in which device an artificial intelligence model to be used by the user is enabled to be driven is automatically determined by software to efficiently use a computing resource.

In an additional embodiment of the present disclosure, a form in which the device and the artificial intelligence model are replaced with each other is also possible to be implemented in the method according to the flowchart of FIG. 3. For example, in response to receiving a target device which is desired to be executed from the user, the computing device 100 may extract device runtime information, device layer information, device memory information, and/or device storage space information of the target device. The computing device 100 may perform the first checking step of determining, by using first model runtime information corresponding to a first artificial intelligence model among a plurality of artificial intelligence models included in a model database, and device runtime information of the target device, whether the first artificial intelligence model is executable by the target device. When it is determined that the first artificial intelligence model is executable by the target device in the first checking step, the computing device 100 may perform the second checking step of determining whether the model resource information of the first artificial intelligence model (stored in the model database) satisfies the target resource condition including the device layer information, the device memory information, and the device storage space information. The computing device 100 may determine whether to include the first artificial intelligence model in the candidate model list executable in the target device and/or recommended for execution in the target device based on a result of the second checking step. A specific methodology in the embodiment may be implemented through the above-described detailed disclosed contents. The technique according to an embodiment of the present disclosure determines which artificial intelligence models are drivable by software in a device designated by the user to reduce a time of collecting information by using hardware, and as a result, a technical effect may be achieved, in which the computing resource may be efficiently used.

It is also possible that checking steps in which contents of the above-described additional embodiment and contents of the above-described embodiment of FIG. 3 are combined.

For example, by combining a model database storing the information on the artificial intelligence model and a device database storing the information on the device, candidate device lists and/or candidate model lists for a case where a desired artificial intelligence model is received from the user, a case where a desired target device is received, and a case where both the desired artificial intelligence model and the desired target device are received may be generated.

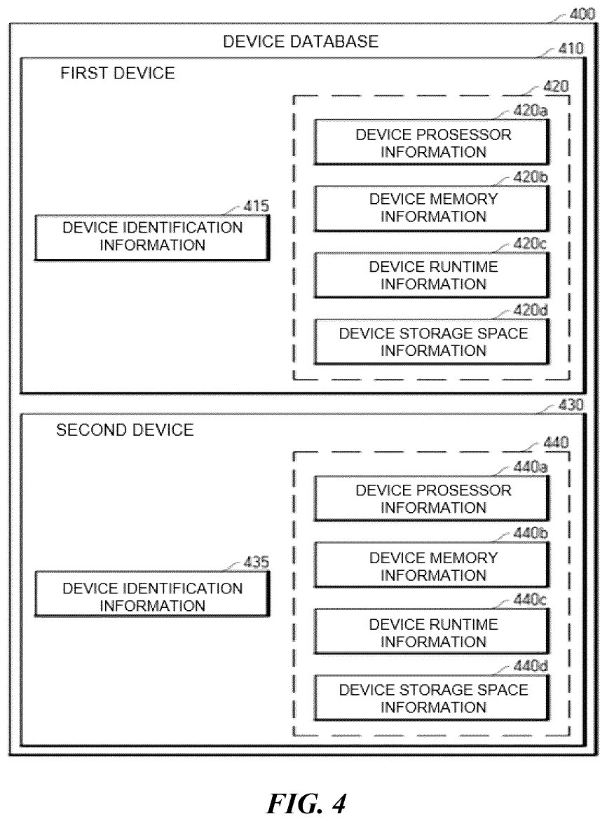

FIG. 4 exemplarily illustrates information stored in a device database 400 according to an embodiment of the present disclosure.

In an embodiment, the device database 400 may be a component included inside the computing device 100.

In an embodiment, the device database 400 may be configured to be located outside the computing device 100 and to communicate with the computing device 100.

In an embodiment, the device database 400 may be managed by a processor 110 or a database management system (DBMS), and tasks including generation, reading, update, deletion, etc., of data may be performed in the device database 400. In an embodiment, the device database 400 may have various forms such as a relational database, a non-relational database, and/or a cloud based database.

In an embodiment, the device database 400 may include information on each of a plurality of devices.

As illustrated in FIG. 4, the device database 400 may include information 410 on the first device. The information 410 on the first device may include device identification information 415 of the first device and/or device resource information 420 of the first device. The device resource information 420 of the first device may include, for example, device processor information 420a, device memory information 420b, device runtime information 420c, and device storage space information 420d. Additionally, the device resource information 420 of the first device may also further include device layer information (not illustrated).

As illustrated in FIG. 4, the device database 400 may include information 430 on the second device. The information 430 on the second device may include device identification information 435 of the second device and/or device resource information 440 of the second device.

The device resource information 440 of the second device may include, for example, device processor information 440a, device memory information 440b, device runtime information 440c, and device storage space information 440d. Additionally, the device resource information 440 of the second device may also further include device layer information (not illustrated).

In FIG. 4, for an example, a state in which information on two devices 410 and 430 stores in the device database 400 illustrated, but it will be apparent to those skilled in the art that information on larger or smaller number of devices may be stored in the device database 400 according to the implementation aspect.

In an embodiment, the device identification information 415 and 435 may mean any form of information for identifying, expressing, or distinguishing the device. For example, the device identification information 415 and 435 may include a name of the device, a manufacturer of the device, a manufacturing time of the device, security information of the device, license information of the device, software authentication information of the device, a media access control address (MAC) of the device, a CPU serial number, a hard driver serial number, a BIOS serial number, and/or a universally unique identifier (UUID).

In an embodiment, the device resource information 420 and 440 may include device processor information 420a and 440a. The device processor information 420a and 440a may include a core type, the number of cores, a core-specific clock speed, L2 cache information, and/or L3 cache information of the processor of the device. For example, the device processor information 420a and 440a may be used to estimate the inference latency when the artificial intelligence model is executed by the device. As a result, it may be determined whether the corresponding device satisfies a target inference latency condition designated by the user or automatically determined. For example, the device processor information 420a and 440a may be used to estimate the inference latency when the artificial intelligence model is executed by the device. As a result, it may be determined whether the corresponding device satisfies a target inference latency condition designated by the user or automatically determined. For example, an inference latency estimation value or an inference latency ratio of the device when the model is executed may be determined by using at least one of factors included in the device processor information 420a and 440a. The inference latency estimation value or inference latency ratio is used jointly with an inference latency estimation value or an inference latency ratio of the model itself to estimate the inference latency of the model for the device.

In an embodiment, the device resource information 420 and 440 may include device memory information 420b and 440b. The device memory information 420b and 440b may represent a size of the memory of the device. The device memory information 420b and 440b may represent a size of an available memory except for a memory size occupied by a program (e.g., an OS program, etc.) currently installed in the device in a total memory size of the device.

In an embodiment, the device resource information 420 and 440 may include device runtime information 420c and 440c. The device runtime information 420c and 440c may represent runtime information supportable by the device. The device runtime information 420c and 440c may have a list-type data structure representing a plurality of runtime information supportable by the device. The device runtime information 420c and 440c may represent runtime information which may be supported optimally (e.g., which may have a best performance) in the corresponding device among the runtime information supportable by the device. For example, the computing device 100 may extract device layer information supportable by the corresponding device through the device runtime information 420c and 440c. In such an example, the computing device 100 may manage the runtime information and a list of supportable layers to be mapped to each other.

In an embodiment, the device resource information 420 and 440 may include device storage space information 420c and 440c. The device storage space information 420c and 440c may represent a file storage capacity of the device. The device storage space information 420c and 440c may represent a size of an available storage space except for a size of a storage space occupied by a program (e.g., an OS program, etc.) currently installed in the device in a total storage space of the device.

In an embodiment, as a new device is obtained, the device database 400 may be updated in a form of adding identification information and device resource information of the corresponding device.

In an additional embodiment of the present disclosure, a model database (not illustrated) storing a model resource condition for each artificial intelligence model may be constructed. As described above in the description of FIG. 3, the model database may store identification information and model resource information (for example, model layer information, model memory information, model file size information, and/or model runtime information) for each of a plurality of artificial intelligence models.

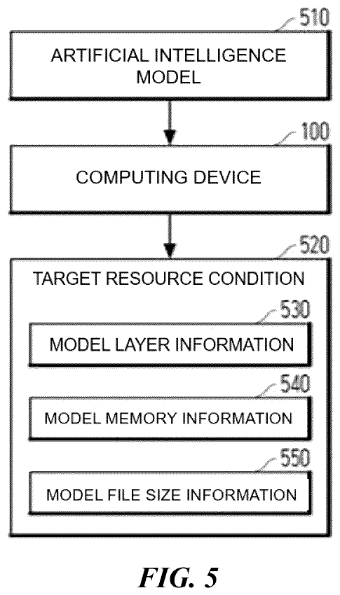

FIG. 5 exemplarily illustrates a target resource condition 520 extracted from the artificial intelligence model 510 according to an embodiment of the present disclosure.

In an embodiment, the computing device 100 may receive the artificial intelligence model 510. The artificial intelligence model 510 may include identification information the artificial intelligence model which is desired to be executed by the device and/or a file of the artificial intelligence model.

In an embodiment, the computing device 100 may generate the target resource condition 520 corresponding to the artificial intelligence model 510 in response to inputting or receiving the artificial intelligence model 510.

In an embodiment, the target resource condition 520 may be used to define a condition to be compared with the device resource information stored in the device database 400. In an embodiment, the target resource condition 520 may represent a condition for executing the received artificial intelligence model 510. In an embodiment, the target resource condition 520 may represent a condition for executing the received artificial intelligence model 510 in the device.

In an embodiment, the target resource condition 520 may be determined through a combination of information 530, 540, and/or 550 related to one or more model resources.

For example, the target resource condition 520 may include model layer information 530 which identifies layers or operators included in the model. The layer and the operator in the present disclosure may be used interchangeably with each other. The model layer information 530 may correspond to information for identifying layers used in an inference process of the model. The model layer information 530 may correspond to information for identifying a layer representing a function performed during an operation process of the model. The model layer information 530 may correspond to information for identifying a plurality of layers which generate an input and output within the model.

For example, the target resource condition 520 may include model memory information 540 which represents a size of a memory used or occupied by the model when the model is executed. The model memory information 540 may quantitatively represent a memory usage occupied by the model. The model memory information 540 may quantitatively represent a maximum value of the memory usage occupied by the model. The model memory information 540 may include information for identifying a memory type suitable for or optimal to execution of the model.

For example, the target resource condition 520 may include model file size information 550 which represents a size of a storage space occupied by the model when the model is executed or installed. The model file size information 550 may quantitatively represent a size of a storage space occupied by a model file. The model file size information 550 may quantitatively represent a maximum value of the size of the storage space occupied by the model file.

In an embodiment, the target resource condition 520 may further include information related to the inference performance when the model is inferred. Although not illustrated in FIG. 5, a combination of one or more of the following information related to the inference performance may be included in the target resource condition 520.

For example, an inference latency representing a time from a time when execution is started to a time when a result is output when the model is executed by the device may be included in the target resource condition 520. The inference latency may include time threshold information designated by the user or automatically determined. The target resource condition 520 for the inference latency may be expressed as a predefined maximum value of the inference latency. The inference latency may also be included in the target resource condition 520 in the process of determining the candidate device.

For example, the power consumption in the process of executing the model in the device may be included in the target resource condition 520. The power consumption may include power size threshold information designated by the user or automatically determined. The target resource condition 520 for the power consumption may be expressed as a predefined maximum value of the power consumption. The power consumption may also be included in the target resource condition 520 in the process of determining the candidate device.

For example, fan usage or board temperature information in the process of executing the model in the device may be included in the target resource condition 520. The fan usage or board temperature information may include threshold information designated by the user or automatically determined. The target resource condition 520 for the fan usage or board temperature information may be expressed as a predefined maximum value of the fan usage or board temperature information. The fan usage or board temperature information may also be included in the target resource condition 520 in the process of determining the candidate device.

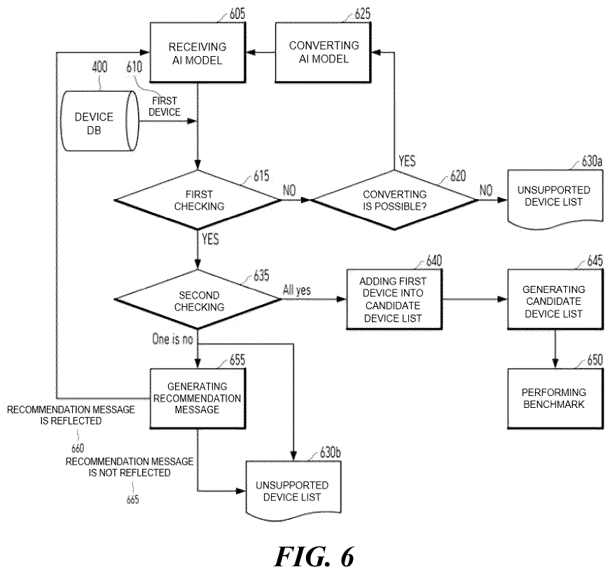

FIG. 6 illustrates an exemplary flowchart for generating a candidate device list according to the embodiment of the present disclosure.

The flowchart illustrated in FIG. 6 is created for the purpose of an example, and an additional step may be included in the flowchart of FIG. 6 or some steps of the flowchart in FIG. 6 may be omitted or modified according to the implementation aspect.

In an embodiment, the computing device 100 may receive the artificial intelligence model (605).

In an embodiment, when the artificial intelligence model is received, the computing device 100 may perform checking (615 and/or 635) for each of the plurality of devices stored in the device database 400. The computing device 100 performs the operations illustrated in the flowchart of FIG. 6 to determine to add each of the plurality of devices stored in the device database 400 to the candidate device list or to the unsupported device list.

In an embodiment, a first device 610 may be extracted from the device database 400.

For example, the computing device 100 may determine the first device 610 among the plurality of devices stored in the device database 400 by using past history information. Here, the past history information may include information on a past checking history for a specific model. As an example, in a situation in which the first device 610 is determined as a device suitable for a specific model during a past checking process, the computing device 100 may determine checking the first device 610 preferentially to other devices by referring to past checking history information among the plurality of devices.

For example, the computing device 100 may randomly determine the first device 610 among the plurality of devices stored in the device database 400.

For example, the computing device 100 may determine a priority of devices to be compared with the received artificial intelligence model by using device resource information among the plurality of devices stored in the device database 400. For example, the computing device 100 may determine an order of a device which is to perform checking in the device database 400 based on device memory information (for example, by granting a high priority to a device having a large available memory). For example, the computing device 100 may determine an order of a device which is to perform checking in the device database 400 based on device storage space information (for example, by granting a high priority to a device having a large size of an available storage space). For example, the computing device 100 may determine an order of a device which is to perform checking in the device database 400 based on device runtime information or based device processor information. For example, the computing device 100 may determine an order of a device which is to perform checking in the device database 400 based on inference performance (e.g., latency) of the device. In such an example, the order of the device which is to perform checking in the device database 400 may be determined based on an average value of inference performances (e.g., inference latencies) of models for each specific device.

In an embodiment, the computing device 100 may extract the target resource condition from the artificial intelligence model. A specific description for the target resource condition will be replaced with the contents described above in FIG. 5.

In an embodiment, the computing device 100 may perform checking (for example, first checking 615 and/or second checking 635) of comparing the target resource condition of the artificial intelligence model and device resource information of the first device 610.

In an embodiment, the computing device 100 may perform the first checking 615 of comparing device runtime information of the first device 610 and model runtime information of the target resource condition. For example, the computing device 100 may determine whether device runtime information representing a runtime supportable by the first device 610 and model runtime information which may support the artificial intelligence model correspond to each other or coincide with each other.

In an embodiment, the computing device 100 may determine whether the first checking 615 is passed. The first checking 615 being passed (Yes in FIG. 6) may indicate the device runtime information of the first device 610 and the model runtime information of the target resource condition correspond to each other. For example, the first checking 615 being passed may indicate that the artificial intelligence model is executable by the first device 610. The first checking 615 being not passed (No in FIG. 6) may indicate the device runtime information of the first device 610 and the model runtime information of the target resource condition do not correspond to each other. For example, the first checking 615 being not passed may indicate that the artificial intelligence model is not executable by the first device 610.

In an embodiment, the computing device 100 may determine whether to convert the artificial intelligence model so that the artificial intelligence model has the device runtime information of the first device 610 when the first checking is not passed (No) (620). For example, when the device runtime information does not match the model runtime condition, the computing device 100 may check whether it is possible to convert the artificial intelligence model to have a runtime operable in the first device 610, and generate a recommendation message for recommending converting the artificial intelligence model when it is determined that it is possible to convert the artificial intelligence model. In an embodiment, when it is determined that it is possible to convert the model, a prompt indicating whether to convert to the artificial intelligence model suitable for the runtime of the first device 610 may be generated, and a process in which converting according to reception of an additional input of the user is performed or converting is automatically performed may be performed. In an embodiment, when it is determined that it is not possible to convert the artificial intelligence model, the artificial intelligence model input by the user may not be driven by the first device 610, so the computing device 100 may include the first device 610 in an unsupported device list 630a.

In an embodiment, when it is determined that it is possible to convert the artificial intelligence model (Yes), the computing device 100 may convert the artificial intelligence model to be operable at the runtime supported by the first device 610 (625).

For example, converting may be performed by a converting module of the computing device 100 or performed through an external converting entity. The first checking 615 in which comparison with device runtime information of the first device 610 is performed may be performed for the converted artificial intelligence model. In this case, the target resource condition may be extracted from the converted artificial intelligence model, and the extracted target resource condition and the device resource information of the first device 610 may be compared. As described above, in the technique according to an embodiment of the present disclosure, when the runtime of the device and the runtime of the artificial intelligence model do not correspond to each other, converting of changing the runtime of the artificial intelligence model is performed to change a target resource condition (e.g., model runtime condition) corresponding to the artificial intelligence model. The first checking 615 and/or the second checking 635 may be performed based on the changed target resource condition.

For example, the converting may include changing a model having a first type of framework or a first type of runtime to a model having a second type of framework or a second type of runtime. For example, the converting may include changing a first operator of the model to a second operator of the model. For example, the converting may include changing a first layer of the model to a second layer of the model.

For example, the computing device 100 may convert the artificial intelligence model into a framework (e.g., TensorRT) supported by the first device when it is determined that the framework (e.g., runtime) of the artificial intelligence model corresponds to Onnxruntime and Onnxruntime is not supported from the device runtime information of the first device.

When it is determined that it is impossible to convert the artificial intelligence model in step 620 (No), the computing device 100 may include the first device 610 in the unsupported device list 630a of the artificial intelligence model. In an embodiment, the unsupported device list 630a may be expressed as a device list which does not support the runtime. In an embodiment, when the first device 610 is included in the unsupported device list 630a, an indication that the runtime of the first device 610 does not match the runtime of the artificial intelligence model.

In an embodiment, the computing device 100 may perform the second checking 635 of determining whether the device resource information of the first device satisfies the target resource condition of the artificial intelligence model when the first checking 615 is passed.

In an embodiment, the second checking 635 may be operated dependently to a result of the first checking 615 as a separate procedure from the first checking 615 according to the implementation aspect. In another embodiment, the second checking 635 and the first checking 615 may be integrated into one checking procedure according to the implementation aspect. In this case, the condition related to the runtime of the model is included in the target resource condition (a memory condition, a storage space condition, and/or a layer condition) of the model to determine whether a plurality of conditions are satisfied by a single checking process.

In an embodiment, when the computing device 100 determines that the second checking 635 is passed (All yes), the computing device 100 may determine to add the first device 610 to the candidate device list (640). In an embodiment, when it is determined that the device resource information satisfies a plurality of target resource conditions (e.g., model layer information, model memory information, model file size information, and/or model runtime information) in the second checking 635, it may be determined that the second checking 635 is passed. A candidate device list including devices that satisfy all of the target resource conditions may be generated in the second checking 635 (645). For example, when an available memory according to the device memory information of the first device 610 is larger than a used memory according to the model memory information of the target resource condition, when an available storage space according to the device storage space information of the first device 610 is larger than a file size according to the model file size information of the target resource condition, and when the model layer information of the target resource condition matches a supportable layer according to the device layer information of the first device 610, the computing device 100 may determine that the first device 610 passes through the second checking 635.

The candidate devices in the present disclosure may support the artificial intelligence model, and correspond to the devices that satisfy the target resource condition of the artificial intelligence model. In an embodiment, the candidate devices may include devices that may support an execution environment or a framework corresponding to the received artificial intelligence model and satisfy the layer condition, the memory condition, and/or the file size condition of the received artificial intelligence model, among devices under the management of the computing device 100 (e.g., the devices stored in the device database 400). Additionally, the candidate devices may include devices that additionally satisfy the inference performance condition (e.g., inference latency, etc.) of the artificial intelligence model in the above-described condition.

In another embodiment, the computing device 100 may also automatically determine a device with the highest performance based on a specific factor (e.g., latency) from the candidate device list as the target device with no user input.

In an embodiment, the candidate device list may include identification information for each of the candidate devices, and performance information (e.g., latency information) for each of the candidate devices when the artificial intelligence model is executed. In an embodiment, the latency information may include an estimated inference time when the model of each device is executed. It may be indicated that as a value of the latency information is smaller, the inference time is shorter. Accordingly, since the value of the latency may be interpreted as a performance indicator for a combination of the model and the device, the computing device 100 may provide a candidate device list sorted based on the size of the latency information. In such an example, a candidate device list including candidate devices sorted in descending order of the size of the latency information may be provided.

In an embodiment, the computing device 100 may determine a target device which becomes a target of the benchmark or a target of the execution of the model based on the user input on the candidate device list.

In an embodiment, the computing device 100 may deliver the candidate device list to a computing device (e.g., a user device) that inputs/transmits the artificial intelligence model. A target device on which the benchmark will be performed may be determined according to the user input on the candidate device list.

In an embodiment, the identification information for the candidate device may include an item name corresponding to the hardware. In an embodiment, the identification information for the candidate device may include installed execution environment information, library information for the execution environment, power mode information, fan mode information, temperature information of a current board, and/or power usage information of the current board. For example, the power mode information may be determined based on how many CPU cores are used. For example, when all CPU cores are used, the power mode information will be determined as MAX, and may also be determined in a scheme of quantitatively expressing usage, such as 30 W, 20 W, 15 W, and 10 W. For example, the larger the quantitative amount of the power mode information, the lower the latency may be. As another example, when the power mode is MAX, the latency may be lower than that of another device that does not use the power mode. For example, the fan mode information may be expressed in the form of information indicating the intensity of the fan, such as Null, Quiet, and Cool. As an example, when the fan mode is Quiet, the temperature of the board may be lowered more than when the fan mode is Null, so there is a high possibility of lower latency. As an example, when the fan mode is the cool mode, the temperature of the board may be lowered more than when another mode, so there is the high possibility of lower latency. For example, the library information may indicate library information required to install execution environment (e.g., runtime) information installed on a specific device. Depending on the characteristics of the device, a plurality of execution environments may be included, and accordingly, the library information may also be compatible with the plurality of execution environments. The power consumption of the current board may represent a power consumption obtained from a power measurement sensor connected to the device. It may be interpreted that the smaller the power consumption value of the current board, the higher the usability of the device.

In an additional embodiment, a sorting order of the candidate devices on the candidate device list may be determined based on a factor(s) including a memory usage and/or a CPU occupancy rate. For example, the sorting order of the candidate devices may be determined based additionally on the memory usage and the CPU occupancy as well as the latency information. As described above, for devices that do not have a significant difference in latency information of the candidate devices, the sorting order of the candidate devices in the candidate device list may be determined by considering additional factors. In providing the candidate device list as such, the candidate devices are sorted in a form that allows the user to intuitively check the performances of the devices, so the user may more easily and efficiently check the performances of the devices on the candidate device list and more efficiently determine the target device.

In an embodiment, one or more target devices may be selected on the candidate device list. A benchmark result may be generated, which is obtained as the artificial intelligence model is executed on the target device (650).

In an embodiment, the computing device 100 may generate the benchmark result as the artificial intelligence model is executed or inferred by the target device. The benchmark result may be generated by the computing device 100 or generated by another server which is under the management of the computing device 100.

In an embodiment, the benchmark result may include the performance information at the target device of the artificial intelligence model. For example, the benchmark result may include time information including preprocessing time information required for preprocessing inference of the artificial intelligence model in the target device or inference time information required for inferring the target device in the artificial intelligence model. In an embodiment, the benchmark result may include memory usage information including preprocessing memory usage information required for preprocessing inference of the artificial intelligence model in the target device or inference memory usage information required for inferring the artificial intelligence model in the target device.

In an additional embodiment, the benchmark result may include memory footprint information required for executing the artificial intelligence model in the target device, latency information required for executing the artificial intelligence model in the target device, and power consumption information required for executing the artificial intelligence model in the target device.

In an embodiment, the benchmark result may include, for example, a table-form data structure.

In an embodiment, when one condition among the target resource conditions is not satisfied in the second checking 635 (one is no), the first device 610 may be included in an unsupported device list 630b.

In an embodiment, when one condition among the target resource conditions is not satisfied in the second checking 635 (one is no), the computing device 100 may generate a recommendation message for changing a condition which is not satisfied (655).

In an embodiment, the recommendation message may be generated for each unmatched condition. The recommendation message may be generated for each device. For example, when the device resource information of the first device 610 does not satisfy a power consumption condition among the target resource conditions, a recommendation message for changing the power consumption condition may be generated. For example, when the device resource information of the first device 610 does not satisfy an inference latency condition among the target resource conditions, a recommendation message for changing the inference latency condition may be generated.

In an embodiment, when the model layer information of the artificial intelligence model and the device layer information of the first device 610 do not match each other, a recommendation message for recommending the change of the layer to the layer supportable by the first device 610 may be generated.

In an embodiment, when the model file size of the artificial intelligence model is larger than the available storage space of the first device 610, the computing device 100 may determine a difference value acquired by subtracting the size of the available storage space of the first device 610 from the model file size, and generate a recommendation message including a compression method and/or a quantization method for reducing the model file size to the different value or more.

In an embodiment, when the model memory usage of the artificial intelligence model is larger than the available memory size of the first device 610, the computing device 100 may determine a difference value acquired by subtracting the available memory size of the first device 610 from the model memory usage, and generate a recommendation message including a compression method and/or a quantization method for reducing the model memory usage to the different value or more.

In an embodiment, the recommendation message may be delivered to the user, and a model conversion operation for the recommendation message may be performed in response to a user input of determining whether to apply the recommendation message of the user. Here, the model conversion operation may include converting of the model, compression of the model, and/or quantization of the model.

In an embodiment, the computing device 100 may determine whether accuracy loss is present when the converted artificial intelligence model is executed by the first device. When it is determined that a size of the accuracy loss exceeds a threshold value, it may be determined that re-training for the converted model is required. Otherwise, it may be determined that re-training is not required. When it is determined that re-training is required, the computing device 100 may perform re-training the artificial intelligence model. The computing device 100 may generate a request message for requesting a training dataset for retraining the artificial intelligence model. When re-training is required, the computing device 100 may include information indicating whether re-training is required, information indicating whether the accuracy loss according to model conversion is present, and/or a degree of the accuracy loss according to model conversion in the recommendation message.

In an embodiment, when the user input from the user is an input indicating reflection of the recommendation message (660), the computing device 100 may perform model conversion according to the recommendation message, and re-perform the step in FIG. 6 from step 605 by using the converted artificial intelligence model.

As described above, the technique according to an embodiment of the present disclosure may determine whether the target resource condition of the received artificial intelligence model is satisfied with respect to each of the plurality of devices stored in the device database 400, and recommend conversion of the artificial intelligence model for changing or modifying the corresponding condition when at least some of the target resource conditions are not satisfied. As a result, the technique according to an embodiment of the present disclosure may more efficiently determine the candidate device recommended for the artificial intelligence model while efficiently using the computing resource.

In an embodiment, when the user input from the user is an input indicating that the recommendation message is not reflected (665), the computing device 100 may include the first device 610 in the unsupported device list 630b. For example, information for identifying what information not satisfying the target resource condition of the artificial intelligence model is among the device resource information may be added to the unsupported device list 630b. For example, the unsupported device list 630b may be generated as a condition unit which is not satisfied among the target resource conditions.

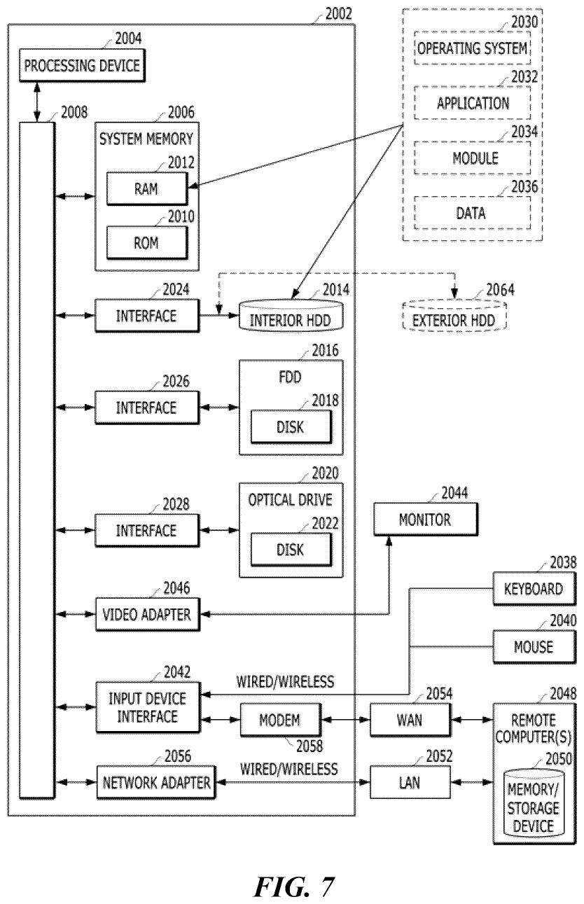

FIG. 7 is a schematic view of a computing environment of the computing device 100 according to an embodiment of the present disclosure.

In this disclosure, computing devices, computing apparatuses, computers, systems, components, modules, or units include routines, procedures, programs, components, and data structures that perform specific tasks or implement specific abstract data types. Further, those skilled in the art will recognize that the methods presented in this disclosure can be implemented on various computer system configurations, including single-processor or multi-processor computing devices, minicomputers, mainframe computers, as well as personal computers, handheld computing devices, microprocessor-based or programmable appliances, and others (the respective devices may operate in connection with one or more associated devices).

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (e.g., EIDE, SATA), an external hard disk (e.g., USB, Thunderbolt, eSATA) 2064, a magnetic floppy disk drive (FDD) 2016 (e.g., for reading from or writing to a removable diskette 2018), solid-state drives (SSD), and an optical disk drive 2020 (e.g., for reading from a CD-ROM disc 2022 or from other high-capacity optical media such as DVDs, or writing to them). The hard disk drives 2014 and 2064, magnetic disk drive 2016, and optical disk drive 2020 can each be connected to the system bus 2008 through their respective interfaces: a hard disk drive interface 2024, a magnetic disk drive interface 2026, and an optical drive interface 2028. The interface 2024 for implementing external drives may include, for example, at least one of or both USB (Universal Serial Bus) and IEEE 1394 interface technologies.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for determining a target device on which an artificial intelligence model is to be executed, performed by a computing device, comprising:
in response to receiving the artificial intelligence model from a user terminal, extracting information related to the artificial intelligence model, wherein the information related to the artificial intelligence model comprises model runtime information, model layer information, model memory information, and model file size information;
when the information related to the artificial intelligence model is extracted, a first checking step: to send a signal, to a device database, requesting information of a first device among a plurality of devices included in the device database, and to determine whether the artificial intelligence model is executable on the first device by using first device runtime information corresponding to the first device and model runtime information of the artificial intelligence model in response to receiving the information of the first device from the device database;
when the artificial intelligence model is determined to be executable on the first device in the first checking step, a second checking step to determine whether device resource information of the first device satisfies target resource conditions, which include the model layer information, the model memory information, and the model file size information of the artificial intelligence model; and
determining whether to include the first device in a candidate device list recommended for executing the artificial intelligence model, based on a result of the second checking step.

2. The method of claim 1, wherein the device resource information comprises:
device processor information used to estimate an inference latency of the artificial intelligence model;
device memory information indicating a memory type or a memory size of the first device;
device runtime information indicating a runtime that is executable on the first device; and
device storage space information indicating an available storage capacity of the first device; and
wherein the device resource information is mapped to the first device and stored in the device database.

3. The method of claim 1, wherein the model memory information is extracted by determining an estimated memory usage when the artificial intelligence model is executed, by using the model runtime information of the received artificial intelligence model, and wherein the model layer information that identifies one or more layers constituting the artificial intelligence model is extracted by using the model runtime information of the received artificial intelligence model.

4. The method of claim 1, further comprising:
when it is determined in the first checking step that the artificial intelligence model is not executable on the first device, transmitting the artificial intelligence model and device runtime information supportable by the first device to a converter; and
receiving the artificial intelligence model converted to have device runtime information supportable by the first device from the converter.

5. The method of claim 4, wherein the extracting step and the second checking step are performed on the converted artificial intelligence model.

6. The method of claim 1, wherein the first checking step determines whether the artificial intelligence model is executable on the first device, by checking if the model runtime information of the artificial intelligence model matches first device runtime information that provides the highest performance among a plurality of device runtime information executable on the first device.

7. The method of claim 1, wherein the determining whether to include the first device in the candidate device list comprises:
when it is determined in the second checking step that the device resource information of the first device satisfies the target resource conditions of the artificial intelligence model, including the first device in the candidate device list recommended for executing the artificial intelligence model; and
wherein the method further comprises:
generating the candidate device list that includes a plurality of candidate devices including the first device;
generating performance information of the artificial intelligence model by executing the artificial intelligence model on a selected target device from the candidate device list; and
generating benchmark results including the performance information.

8. The method of claim 1, wherein the determining whether to include the first device in the candidate device list comprises:
when it is determined that the device resource information of the first device does not satisfy the target resource conditions, excluding the first device from the candidate device list and including the first device in an unsupported device list corresponding to the artificial intelligence model.

9. The method of claim 8, wherein the including the first device in the unsupported device list comprises:
when device layer information of the device resource information of the first device does not support the model layer information, including the first device in an unsupported layer device list;
when device memory information of the device resource information of the first device does not satisfy a size of the model memory information, including the first device in an unsupported memory device list; and
when device storage space information of the device resource information of the first device does not satisfy the model file size information, including the first device in an unsupported storage device list.

10. The method of claim 1, wherein in the second checking step, it is determined that the device resource information of the first device does not satisfy the target resource conditions when any one of the device layer information, device memory information and device storage space information included in the device resource information of the first device does not satisfy the target resource conditions.

11. The method of claim 1, further comprising:
generating a recommendation message suggesting an additional operation to be applied to the artificial intelligence model to modify the target resource conditions, when it is determined in the second checking step that the device resource information of the first device does not satisfy the target resource conditions of the artificial intelligence model.

12. The method of claim 11, wherein the generating the recommendation message comprises:
generating the recommendation message including candidate layers supporting a runtime of the first device, when the device layer information in the device resource information does not match the model layer information in the target resource conditions, and
wherein the method further comprises:
transmitting the recommendation message including candidate layers supporting the runtime of the first device to the user terminal;
receiving a user input selecting the candidate layer from the user terminal;
transmitting a converting request to the converter to replace at least some of the layers of the artificial intelligence model with the selected candidate layer, in response to receiving the user input; and
receiving the converted artificial intelligence model from the converter.

13. The method of claim 12, wherein it is determined whether the replacement with the candidate layer requires retraining of the artificial intelligence model, based on the candidate layer and the layer to be replaced in the artificial intelligence model, and the recommendation message indicates whether retraining of the artificial intelligence model is necessary.

14. The method of claim 11, wherein the recommendation message is generated to include a memory reduction amount required to match the model memory information to the device memory information and a compression technique of the artificial intelligence model to achieve the memory reduction amount, when the device memory information in the device resource information does not match the model memory information in the target resource conditions; and
wherein the recommendation message is generated to include a file size reduction amount required to match the model file size information to the device storage space information and a compression technique of the artificial intelligence model to achieve the file size reduction amount, when the device storage space information in the device resource information does not match the model file size information in the target resource conditions; and
wherein the method further comprises:
in response to receiving a user input selecting the compression technique from the user terminal, transmitting a compression request including the selected compression technique and the artificial intelligence model to a compression server to generate a compressed artificial intelligence model; and
receiving the compressed artificial intelligence model from the compression server as the selected compression technique is applied to the artificial intelligence model.

15. The method of claim 11, wherein the recommendation message is generated to include a memory reduction amount required to match the model memory information to the device memory information and a quantization technique of the artificial intelligence model to achieve the memory reduction amount, when the device memory information in the device resource information does not match the model memory information in the target resource conditions; and
wherein the recommendation message is generated to include a file size reduction amount required to match the model file size information to the device storage space information and a quantization technique of the artificial intelligence model to achieve the file size reduction amount, when the device storage space information in the device resource information does not match the model file size information in the target resource conditions; and
wherein the method further comprises:
in response to receiving a user input selecting the quantization technique from the user terminal, transmitting a quantization request including the selected quantization technique and the artificial intelligence model to a quantization server to generate a quantized artificial intelligence model; and
receiving the quantized artificial intelligence model from the quantization server as the selected quantization technique is applied to the artificial intelligence model.

16. The method of claim 1, further comprising:
identifying unsupported information that does not satisfy the target resource conditions within the device resource information, when it is determined in the second checking step that the device resource information of the first device does not satisfy the target resource conditions of the artificial intelligence model; and
generating a recommendation message to suggest an additional operation to satisfy the target resource conditions in different manners according to the identification result of the unsupported information.

17. The method of claim 11, further comprising:
re-performing the first checking step and the second checking step using the artificial intelligence model to which an additional operation is applied and the first device, when the additional operation is applied to the artificial intelligence model according to the recommendation message.

18. The method of claim 1, wherein the determining whether to include the first device comprises:
a third checking step to determine whether an inference latency of the artificial intelligence model satisfies a predefined target inference latency or whether a power consumption of the artificial intelligence model satisfies a predefined target power consumption when the artificial intelligence model is executed on the first device, when it is determined in the second checking step that the device resource information satisfies the target resource conditions; and
determining whether to include the first device in the candidate device list recommended for executing the artificial intelligence model, based on a result of the third checking step.

19. A computer program stored in a non-transitory computer-readable medium, wherein when the computer program is executed by a processor of a computing device, the computer program allows the processor of the computing device to perform a method for a target device on which an artificial intelligence model is to be executed, and the method comprises:
in response to receiving the artificial intelligence model from a user terminal, extracting information related to the artificial intelligence model, wherein the information related to the artificial intelligence model comprises model runtime information, model layer information, model memory information, and model file size information;
when the information related to the artificial intelligence model is extracted, a first checking step: to send a signal, to a device database, requesting information of a first device among a plurality of devices included in the device database, and to determine whether the artificial intelligence model is executable on the first device by using first device runtime information corresponding to the first device and model runtime information of the artificial intelligence model in response to receiving the information of the first device from the device database;
when the artificial intelligence model is determined to be executable on the first device in the first checking step, a second checking step to determine whether device resource information of the first device satisfies target resource conditions, which include the model layer information, the model memory information, and the model file size information of the artificial intelligence model; and
determining whether to include the first device in a candidate device list recommended for executing the artificial intelligence model, based on a result of the second checking step.

20. A computing device comprising:
a processor; and
a memory;
wherein the processor performs:
in response to receiving the artificial intelligence model from a user terminal, an operation for extracting information related to the artificial intelligence model, wherein the information related to the artificial intelligence model comprises model runtime information, model layer information, model memory information, and model file size information;
when the information related to the artificial intelligence model is extracted, a first checking operation: to send a signal, to a device database, requesting information of a first device among a plurality of devices included in the device database, and to determine whether the artificial intelligence model is executable on the first device by using first device runtime information corresponding to the first device and model runtime information of the artificial intelligence model in response to receiving the information of the first device from the device database;
when the artificial intelligence model is determined to be executable on the first device in the first checking operation, a second checking operation to determine whether device resource information of the first device satisfies target resource conditions, which include the model layer information, the model memory information, and the model file size information of the artificial intelligence model; and
an operation for determining whether to include the first device in a candidate device list recommended for executing the artificial intelligence model, based on a result of the second checking operation.
